(19) United States
(12) Patent Application Publication
(10) Pub. No.: US 2006/0022577 A1
(43) Pub. Date: Feb. 2, 2006

(54) Electron emission device and method for manufacturing

(76) Inventor: You-Jong Kim, Suwon-si (KR)

Correspondence Address: CHRISTIE, PARKER & HALE, LLP, PO BOX 7068, PASADENA, CA, 91109-7068, US

(21) Appl. No.: 11/191,360

(22) Filed: Jul. 27, 2005

(30) Foreign Application Priority Data
Jul. 30, 2004 (KR) 10-2004-0060606

(51) Int. Cl. H01J 1/62

(52) U.S. Cl. 313/497

(57) ABSTRACT

An electron emission device includes first and second substrates facing each other, cathode electrodes formed on the first substrate, and electron emission regions formed on the cathode electrodes. Gate electrodes are formed on the cathode electrodes with a first insulating layer interposed between them. A focusing electrode is formed on the first insulating layer and the gate electrodes with a second insulating layer interposed between them. The first insulating layer, the gate electrodes, the second insulating layer and the focusing electrode each have openings exposing the electron emission regions on the first substrate. The size of the opening measured at a surface of the second insulating layer facing the first insulating layer is smaller than the size of the opening measured at a surface of the first insulating layer facing the second insulating layer.

### CROSS REFERENCE TO RELATED APPLICATION

This application claims priority to and the benefit of Korean Patent Application No. 10-2004-0060606 filed on Jul. 30, 2004 in the Korean Intellectual Property Office, the entire content of which is incorporated herein by reference.

### BACKGROUND OF THE INVENTION

1. Field of the Invention

The embodiments of the present invention relate to an electron emission device, and in particular, to an electron emission device and a method of manufacturing the electron emission device, which improves the structure of a focusing electrode for focusing electron beams and an insulating layer for supporting the focusing electrode.

2. Description of Related Art

Generally, electron emission devices are classified into a first type of device where a hot cathode is used as an electron emission source and a second type of device where a cold cathode is used as the electron emission source.

The second type of electron emission devices include field emitter array (FEA) type devices, surface conduction emission (SCE) type devices, metal-insulator-metal (MIM) type devices, and metal-insulator-semiconductor (MIS) type devices.

The electron emission devices have differences in their specific structure depending upon their type, but each device has first and second substrates that form a vacuum vessel. Electron emission regions are formed on the first substrate and driving electrodes are formed thereon to control the electron emission for each respective pixel. Phosphor layers and an anode electrode are formed on the second substrate to emit light or display the desired images.

With the electron emission device, attempts have been made to enhance the display characteristics by guiding the trajectories of electron beams to the target. Because the electrons emitted from the first substrate are not well focused toward the second substrate, they do not strike the correct color phosphor layers and light-emit the incorrect neighboring color phosphor layers.

In response to this problem, a focusing electrode has been introduced to control the electron beams. The focusing electrode is placed on the topmost portion of the structure of the first substrate while surrounding the electron emission regions. An insulating layer is formed under the focusing electrode to prevent the driving electrodes and the focusing electrodes from being electrically connected to each other. Openings are formed in the insulating layer and the focusing electrode, exposing the electron emission regions on the substrate to form the route of migration for the electron beams.

Wet etching is often used in forming the openings in the insulating layer. However, as wet etching is made in an isotropic manner, a deeper etching in the insulating layer results in the width of the openings becoming enlarged, thereby making it difficult to form openings with a high aspect ratio. The aspect ratio refers to the ratio of the depth of the openings to the width thereof.

Particularly with the FEA type electron emission devices, where a first insulating layer is disposed between a pair of driving electrodes and a second insulating layer is disposed between a focusing electrode and one of the driving electrodes, when the openings of the second and the first insulating layers are sequentially formed through wet etching, the second insulating layer is continuously etched until the opening of the first insulating layer is completed. As a result, the opening of the second insulating layer has a width that is larger than intended or desired. That is, the opening of the second insulating layer is larger in width than that of the first insulating layer.

The above-structured electron emission device is limited in achieving high integration and increasing resolution. The focusing electrode is located far from the trajectories of the electron beams, thereby deteriorating the electron beam focusing efficiency. It is noted that the higher the location of the focusing electrode with respect to the electron emission regions, the more enhanced the electron beam focusing efficiency becomes. However, because it is difficult with the above process to form openings with a high aspect ratio in the second insulating layer, a limit is placed on enhancing the electron beam focusing efficiency.

### SUMMARY

In the embodiments of the present invention, an electron emission device is provided that enhances the electron beam focusing efficiency by forming high aspect ratio openings in the insulating layer for supporting the focusing electrode and to enable production of higher resolution devices.

In one embodiment, the electron emission device includes first and second substrates facing each other, cathode electrodes positioned on the first substrate, and electron emission regions formed on the cathode electrodes. Gate electrodes are formed on the cathode electrodes with a first insulating layer between the gate electrodes and cathode electrodes. A focusing electrode is formed on a second insulating layer that is interposed between the gate electrodes and the focusing electrode. The first insulating layer, the gate electrodes, the second insulating layer and the focusing electrode each have openings exposing the electron emission regions on the cathode electrode. The size of the opening, measured at a point in the second insulating layer aligned with the bottom surface of the second layer, which faces the first insulating layer, is smaller than the size of the opening measured at point aligned with a top surface of the first insulating layer, which faces the second insulating layer.

The size of the opening measured at a point aligned with the bottom surface of the second insulating layer, which faces the first insulating layer, may be smaller than the size of the opening of the gate electrode.

The opening of the first insulating layer and the opening of the second insulating layer are varied in width in the direction of the thickness of the first substrate. The minimum width of the second insulating layer opening may be smaller than the maximum width of the first insulating layer opening.

The maximum width and the minimum width of the second insulating layer opening may be smaller than the maximum width and the minimum width of the first insulating layer opening, respectively. The maximum width of the second insulating layer opening may be smaller than or identical with the width of the opening of the gate electrode.

The opening of the second insulating layer and the focusing electrode may be arranged to be in one to one correspondence with the opening of the first insulating layer and the gate electrodes.

The second insulating layer may have an etching rate that is less than the etching rate of the first insulating layer. The etching rate of the second insulating layer may be ⅓ or less of the etching rate of the first insulating layer.

In a method of manufacturing the electron emission device, cathode electrodes are first formed on a substrate. A first insulating layer is formed on the entire surface of the substrate such that it covers the cathode electrodes. Gate electrodes with openings are formed on the first insulating layer. A second insulating layer is formed on the first insulating layer and the gate electrodes with an insulating material having an etching rate less than the first insulating layer. A focusing electrode with openings is formed on the second insulating layer. Openings are formed in the second insulating layer and the first insulating layer by wet-etching the second and the first insulating layers using the focusing electrode and the gate electrodes as a mask such that the opening of the first insulating layer is larger than or identical with the opening of the second insulating layer. Electron emission regions are formed on the cathode electrodes within the openings.

### BRIEF DESCRIPTION OF THE DRAWINGS

FIG. 1 is a partially exploded perspective view of an electron emission device according to an embodiment of the present invention.

FIG. 2 is a partial cross-sectional view of the electron emission device according to one embodiment of the present invention.

FIG. 3 is a cross sectional view of the electron emission device shown in FIG. 2.

FIG. 4A illustrates a first phase of manufacturing the electron emission device according to one embodiment of the present invention.

FIG. 4B illustrates a second phase of manufacturing the electron emission device according to one embodiment of the present invention.

FIG. 4C illustrates a third phase of manufacturing the electron emission device according to one embodiment of the present invention.

FIG. 4D illustrates a fourth phase of manufacturing the electron emission device according to one embodiment of the present invention.

FIG. 4E illustrates a fifth phase of manufacturing the electron emission device according to one embodiment of the present invention.

### DETAILED DESCRIPTION

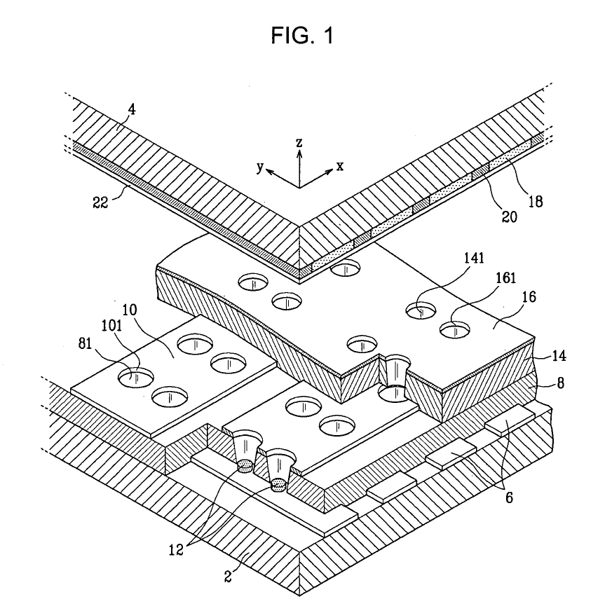

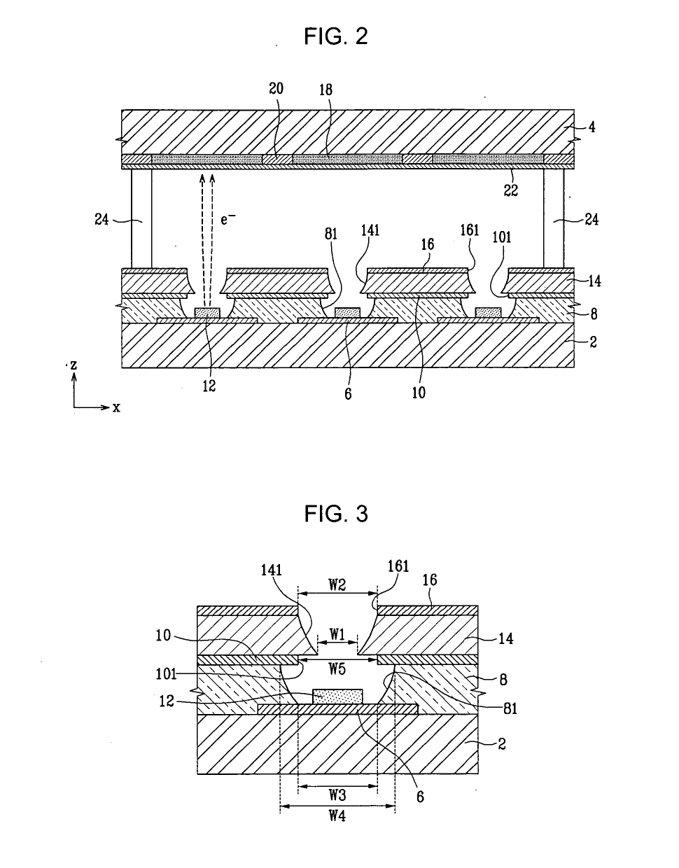

As shown in FIGS. 1 to 3, an electron emission device includes first and second substrates 2 and 4 facing each other at a predetermined distance. An electron emission structure is provided in the first substrate 2 to emit electrons. A light emission or display structure is provided in the second substrate 4 to emit visible rays and display the desired images.

Cathode electrodes 6 are stripe-patterned on the first substrate 2 in a first direction (e.g., in a y axis direction of the drawing). A first insulating layer 8 is formed on the entire surface of the first substrate 2, covering the cathode electrodes 6. Gate electrodes 10 are stripe-patterned on the first insulating layer 8, in a second direction that is perpendicular to the cathode electrodes 6 (e.g., in an x axis direction of the drawing).

The regions where the cathode electrodes 6 and the gate electrodes 10 cross make a formation of sub-pixel regions. One or more electron emission regions 12 are formed on the cathode electrodes 6 in the respective sub-pixel regions. Openings 81 and 101 are formed in the first insulating layer 8 and the gate electrodes 10 corresponding to the respective electron emission regions 12, exposing the electron emission regions 12 on the first substrate 2.

The electron emission regions 12 are formed with a material that emits electrons under the application of an electric field, such as a carbonaceous material or a nanometer-sized material. The electron emission regions 12 may be formed with carbon nanotube, graphite, graphite nanofiber, diamond-like carbon, C₆₀, silicon nanowire, or a combination thereof. The electron emission regions may be formed using the technique of direct growth, screen printing, chemical vapor deposition or sputtering.

A second insulating layer 14 and a focusing electrode 16 are formed on the gate electrodes 10 and the first insulating layer 8. Openings 141 and 161 are also formed in the second insulating layer 14 and the focusing electrode 16, exposing the electron emission regions 12 on the first substrate 2. The focusing electrode 16 is provided with openings 161 corresponding to the respective electron emission regions 12 such that they encircle the trajectories of the electron beams emitted from the electron emission regions 12 to enhance the beam focusing efficiency. That is, in this embodiment, the openings 141 and 161 of the second insulating layer 14 and the focusing electrode 16 are structured to be in one to one correspondence or aligned with the openings 81 and 101 of the first insulating layer 8 and the gate electrodes 10.

It is illustrated in the drawings that the focusing electrode 16 is formed on the entire surface of the first substrate 2, but the focusing electrode 16 may be patterned in other embodiments. Even in this embodiment, openings 141 and 161 are formed in the second insulating layer 14 and the focusing electrode 16, exposing the electron emission regions 12 on a cathode electrode 6 on the first substrate 2.

In the electron emission device according to the embodiments of the present invention, the size of the opening 141 measured at a point aligned with the surface of the second insulating layer 14 facing toward the first insulating layer 8 is established to be smaller than that of the opening 81 measured at a point aligned with the surface of the first insulating layer 8 facing toward the second insulating layer 14. In this embodiment, the size of the opening 141 measured at a point aligned with the surface of the second insulating layer 14 facing toward the first insulating layer 8 is established to be smaller than that of the opening 101 of the gate electrode 10.

Electric fields formed around the electron emission regions 12 are generated by the potential difference between the cathode electrodes 6 and the gate electrodes 10, and cause electrons to be emitted from the electron emission regions 12. The passage for electron beams that are proceeding toward the second substrate 4 is narrowed due to the second insulating layer 14 and the focusing electrode 16 being positioned close to and encircling the route of the electron beam.

The openings 81 of the first insulating layer 8 and the openings 141 of the second insulating layer 14 may be completed through wet etching. In one embodiment, due to the isotropic etching characteristics of the wet etching, the openings 81 and 141 of the two insulating layers 8 and 14 have an inclined surface that gradually enlarges in width as it recedes from the first substrate 2.

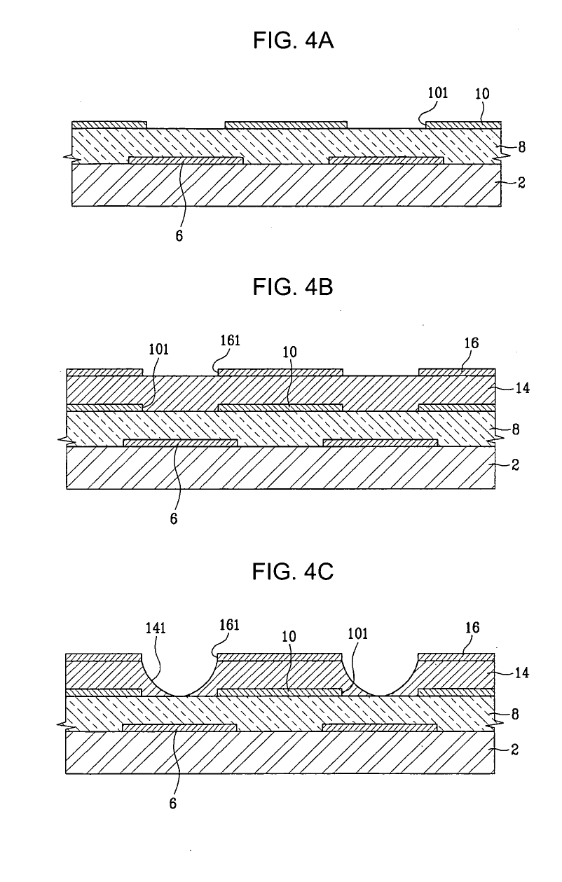

As shown in FIG. 3, the minimum width W1 of the opening 141 of the second insulating layer 14 is established to be smaller than the maximum width W4 of the opening 81 of the first insulating layer 8. The maximum and the minimum widths W2 and W1 of the second insulating layer opening 141 are established to be smaller than the maximum and the minimum widths W4 and W3 of the first insulating layer opening 81, respectively. The maximum width W2 of the second insulating layer opening 141 is less than or equal to the width W5 of the gate electrode opening 101. Therefore, all the openings 141 of the second insulating layer 14 have a width that is less than or equal to the openings 101 of the gate electrodes 10.

The first and the second insulating layers 8 and 4 are formed with materials having different etching rates with respect to a given etching solution or process. In one embodiment, the openings 81 and 141 with the above-identified characteristic shape can be formed through a single etching process. For this purpose, the second insulating layer 14 has an etching rate that is less than the first insulating layer 8. The etching rate of the second insulating layer 14 is established to be ⅓ or less of the etching rate of the first insulating layer 8. A greater difference in etching rate between the first insulating layer 8 and the second insulating layer 14 results in the opening 141 of the second insulating layer 14 being smaller compared to the opening 81 of the first insulating layer 8.

Red, green and blue phosphor layers 18 are formed on a surface of the second substrate 4 facing the first substrate 2 at a distance. Black layers 20 are formed between the phosphor layers 18 to enhance the screen contrast.

An anode electrode 22 is formed on the phosphor layers 18 and the black layers 20 with a metallic film including aluminum (Al). The anode electrode 22 receives a voltage from outside the device that is required for accelerating the electron beams. The anode reflects the visible rays radiated from the phosphor layers 18 toward the first substrate 2 to the second substrate 4, thereby increasing the screen luminance.

Alternatively, the anode electrode may be formed with a transparent conductive film based on indium tin oxide (ITO), instead of the metallic film. In this embodiment, the anode electrode is formed on a surface of the phosphor layers and black layers facing the second substrate. The anode electrode may be patterned with a plurality of different portions.

Spacers 24 are arranged between the first and the second substrates 2 and 4, and the first and the second substrates 2 and 4 are sealed to each other at their peripheries using a sealant, such as a glass frit. The inner space between the first and the second substrates 2 and 4 is evacuated to create a vacuum, thereby constructing an electron emission device. The spacers 24 are placed in the non-light emission area where the black layers 20 are located.

The above-structured electron emission device is driven by applying predetermined voltages from outside to the cathode electrodes 6, the gate electrodes 10, the focusing electrode 16 and the anode electrode 22. For example, driving voltages with a voltage difference of several to several tens of volts (e.g., scanning signal voltages and data signal voltages) are applied to the cathode electrodes 6 and the gate electrodes 10. A negative (−) voltage of several to several tens of volts is applied to the focusing electrode 16, and a positive (+) voltage of several hundreds to several thousands of volts is applied to the anode electrode 22.

Accordingly, electric fields are formed around the electron emission regions 12 at the pixels where the voltage difference between the cathode and the gate electrodes 6 and 10 exceeds a threshold value. Electrons are emitted from those electron emission regions 12. The emitted electrons are focused toward the center of a bundle of electron beams while passing through the focusing electrode 16. The emitted electrons are attracted by the high voltage applied to the anode electrode 22, thereby colliding against the corresponding phosphor layers 18, causing light to emit from them.

In the above process, electrons emitted from the electron emission regions 12 include scattered electrons that are intercepted by the second insulating layer 14 due to the narrowed openings 141, thereby creating a straight path for the electron beams. The electrons that pass through the openings 141 of the second insulating layer 14 are strongly focused by the focusing electrode 16 positioned close to the trajectories of electron beams, thereby enhancing the electron beam focusing efficiency.

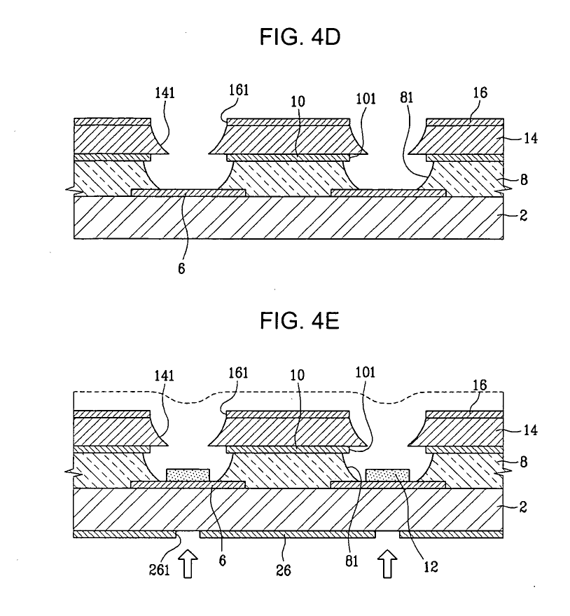

A method of manufacturing the electron emission device according to one embodiment of the present invention will be now explained with reference to FIGS. 4A to 4E.

First, as shown in FIG. 4A, cathode electrodes 6 are formed on a first substrate 2 and laid out in a first direction. A first insulating layer 8 is formed on the entire surface of the first substrate 2, covering the cathode electrodes 6. The first insulating layer 8 may be formed with a thickness of 5-30 μm by repeating a process of screen printing, drying and firing several times.

Gate electrodes 10 are formed on the first insulating layer 8 such that they cross the cathode electrodes 6. The regions where the cathode electrodes 6 and the gate electrodes 10 cross form pixel regions. At least one opening 101 is formed within the gate electrode 10 for each pixel region.

As shown in FIG. 4B, a second insulating layer 14 is formed on the first insulating layer 8 and the gate electrodes 10. The second insulating layer 14 may be also be formed with a thickness of 5-30 μm by repeating the process of screen printing, drying and firing several times. A conductive material is coated on the second insulating layer 14, and patterned to form a focusing electrode 16 with openings 161.

The first and the second insulating layers 8 and 14 are formed with materials bearing different etching rates with respect to an etching solution. The etching rate of the material for the second insulating layer 14 is established to be ⅓ or less of that of the material for the first insulating layer 8.

As shown in FIGS. 4C and 4D, the second and the first insulating layers 14 and 8 are etched through one wet etching process using the focusing electrode 16 and the gate electrodes 10 as a mask.

As shown in FIG. 4C, the portions of the second insulating layer 14 exposed through the focusing electrode openings 161 are wet-etched. In this process, the openings 141 of the second insulating layer 14 have an incline caused by the isotropic etching characteristics of the wet etching.

As shown in FIG. 4D, in embodiments where the openings 141 in the second insulating layer 14 reach the first insulating layer 8, exposing the surface of the first insulating layer 8, the first insulating layer 8 is etched to thereby form openings 81. In this process, due to the difference in etching rates between the first and the second insulating layers 8 and 14, the first insulating layer 8 is removed through etching in an amount larger than that of the second insulating layer 14 so that the opening 81 of the first insulating layer 8 has a width that is larger than the opening 141 of the second insulating layer 14.

The second insulating layer 14 and the focusing electrode 16 have openings 141 and 161 that are smaller than the openings 81 of the first insulating layer 8. The minimum width of the second insulating layer opening 141 is smaller than the width of the gate electrode opening 101. A greater difference in etching rate between the first and the second insulating layers 8 and 16 causes the difference in size between the first insulating layer opening 81 and the second insulating layer opening 141 to increase.

Electron emission regions are formed on the cathode electrodes 6 that are exposed through the first insulating layer openings 81. To form the electron emission regions, as shown in FIG. 4E, an organic material, such as a vehicle and/or a binder, and a photosensitive material are mixed with a powdered electron emission material to prepare a paste-phased electron emission material with a viscosity suitable for printing. The electron emission material is screen-printed onto the topmost portion of the structure of the first substrate 2 with a thickness (indicated by the dotted line). An exposure mask 26 with openings 261 is placed at the rear of the first substrate 2. Ultraviolet rays are directed into the printed electron emission material through the backside of the first substrate 2 to selectively harden the electron emission material. The non-hardened electron emission material is removed, followed by drying and firing the hardened material.

When the light exposure is made through the backside of the first substrate 2, the adhesion of the electron emission regions 12 to the cathode electrodes 6 is reinforced and it becomes possible to execute precise patterning. The first substrate 2 is formed with a transparent material and the cathode electrodes 6 are formed with a transparent conductive film based on indium tin oxide (ITO).

In the method of manufacturing the electron emission device according to the embodiments of the present invention, the openings 81 in the first insulating layer 8 and the openings 141 in the second insulating layer 14 are completed through only one etching process. The openings 141 in the second insulating layer 14 are smaller than or identical in size to the openings 81 in the first insulating layer 8 without performing a separate patterning process, thereby enabling easy processing and manufacture.

As described above, in the electron emission device, the electron beams can travel in a relatively straight path due to the shape of the openings in the second insulating layer and the focusing electrode, as a result higher electron beam focusing efficiency can be obtained. Consequently, the color representation of the screen can be enhanced, improved screen quality obtained, and the respective components of the electron emission structure can be arranged in an isolated manner, thereby realizing high resolution.

Although the embodiments discussed above are related to the FEA type electron emission device, the embodiments are not limited thereto. The embodiments may be easily applied to other types of electron emission devices.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An electron emission device comprising:
a first substrate and a second substrate facing each other and separated from each other by a distance;
a plurality of cathode electrodes positioned on the first substrate;
a plurality of electron emission regions formed on the cathode electrodes;
a plurality of gate electrodes formed on the cathode electrodes with a first insulating layer between the gate electrodes and cathode electrodes;
a second insulating layer formed on the first insulating layer and the gate electrodes; and
a focusing electrode formed on the second insulating layer;
wherein the first insulating layer, the gate electrodes, the second insulating layer and the focusing electrode each have openings exposing the electron emission regions on the first substrate, and a size of an opening measured at a point aligned with a surface of the second insulating layer that faces the first insulating layer is smaller than a size of an opening measured at a point aligned with a surface of the first insulating layer that faces the second insulating layer.

2. The electron emission device of claim 1, wherein the size of the opening measured at the point aligned with the surface of the second insulating layer that faces the first insulating layer is smaller than a size of an opening of the gate electrode.

3. The electron emission device of claim 1, wherein an opening of the first insulating layer and an opening of the second insulating layer are varied in width in the direction of the thickness of the first substrate, and wherein a minimum width of the opening of the second insulating layer is smaller than a maximum width of the opening of the first insulating layer.

4. The electron emission device of claim 3, wherein the maximum width of the opening of the second insulating layer is smaller than the maximum width of the opening of the first insulating layer

5. The electron emission device of claim 3, wherein the minimum width of the opening of the second insulating layer is smaller than the minimum width of the opening of the first insulating layer.

6. The electron emission device of claim, 3 wherein the maximum width of the opening of the second insulating layer is smaller than or identical to a width of an opening of the gate electrode.

7. The electron emission device of claim 1, wherein the opening of the second insulating layer and an opening of the focusing electrode are arranged to be in one to one correspondence with the opening of the first insulating layer and an opening of the gate electrode.

8. The electron emission device of claim 1, wherein an etching rate of the second insulating layer is less than an etching rate of the first insulating layer.

9. The electron emission device of claim 8, wherein the etching rate of the second insulating layer is ⅓ or less of the etching rate of the first insulating layer.

10. The electron emission device of claim 1, wherein the electron emission regions are formed with a material that is carbon nanotube, graphite, graphite nanofiber, diamond-like carbon, C₆₀, or silicon nanowire.

11. The electron emission device of claim 1, further comprising at least one anode electrode formed on the second substrate; and
phosphor layers formed on a surface of the at least one anode electrode.

12. A method of manufacturing an electron emission device, comprising:
(a) forming cathode electrodes on a substrate;
(b) forming a first insulating layer on an entire surface of the substrate such that the first insulating layer covers the cathode electrodes;
(c) forming gate electrodes with openings on the first insulating layer;
(d) forming a second insulating layer on the first insulating layer and the gate electrodes, the second insulation layer formed from an insulating material having an etching rate that is less than an etching rate of the first insulating layer;
(e) forming a focusing electrode with openings on the second insulating layer;
(f) forming openings in the second insulating layer and in the first insulating layer by wet-etching using the focusing electrode and the gate electrodes as a mask such that an opening in the first insulating layer is larger than or identical to an opening in the second insulating layer; and
(g) forming electron emission regions on the cathode electrodes within the opening of the first insulation layer, the opening of the second insulation layer, an opening of the focusing electrode and an opening of the gate electrodes.

13. The method of claim 12, wherein the etching rate of a material for the second insulating layer is ⅓ or less of an etching rate of the first insulating layer.

14. The method of claim 12, wherein the opening of the gate electrodes and the opening of the focusing electrode are arranged to be in one to one correspondence with each other.

15. The method of claim 12, wherein a paste-phased photosensitive electron emission material is coated on structures on the substrate and the coated electron emission material is selectively hardened through light exposure, followed by removal of non-hardened electron emission material and drying and firing of hardened electron emission material.

16. The method of claim 12, wherein the electron emission regions are formed with a material that is carbon nanotube, graphite, graphite nanofiber, diamond-like carbon, C₆₀, or silicon nanowire.

17. The method of claim 12, further comprising:
forming phosphor layers on a second substrate.

18. The method of claim 17, further comprising:
forming anode electrodes on the phosphor layers.

19. The method of claim 17, further comprising:
sealing the second substrate with the first substrate.

20. The method of claim 12, further comprising:
etching the second insulating layer at a rate that is ⅓ or less of an etching rate of the first insulating layer
